(19) United States
(12) Patent Application Publication
(10) Pub. No.: US 2016/0019758 A1
(43) Pub. Date: Jan. 21, 2016

(54) Method to create more comparative choices in sports fantasy or other fantasy games

(71) Applicants: George Skaff Elias, Redmond, WA (US); Richard Channing Garfield, Bellevue, WA (US)

(72) Inventors: George Skaff Elias, Redmond, WA (US); Richard Channing Garfield, Bellevue, WA (US)

(21) Appl. No.: 14/545,958

(22) Filed: Jul. 13, 2015

Related U.S. Application Data
(60) Provisional application No. 61/999,063, filed on Jul. 15, 2014.

(51) Int. Cl. G07F 17/32

(52) U.S. Cl. CPC G07F 17/3288

(57) ABSTRACT

This invention is a new method of creating more comparative choices in sports fantasy or other fantasy games, thereby greatly increasing the ability of a game operator to create fairly even bets or comparative choices without the need for point spreads but are still simple for the users or participants to understand.

### CROSS-REFERENCE TO RELATED APPLICATIONS

Applicants are claiming the benefit of a provisional patent application with the same title, No. 61/999063, filed on Jul. 15, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the field of games. More particularly, the present invention is in the field of bet-matching games involving fantasy sports or other fantasy games.

In traditional wagering games, the game operator generally acts as a market maker. The game operator could balance the amounts of bets and expected payout by setting and adjusting the odds that determine the payout of a bet or wager on a particular proposition or by adjusting the spread between the two sides of a comparative bet. For example, a game operator could increase the odds to yield a higher payout in order to attract more bets on an undersubscribed event in the betting pool. A game operator could also add or adjust a point spread to a comparative bet, i.e., adding a required performance condition to raise the winning threshold for one side in order to attract more bets to the other side.

On the other hand, in bet-matching games (which are the subject of another pending patent application by the same inventors), the game operator does not act as a market maker but will facilitate the pairing of bets for and against a particular proposition, or on each side of a particular comparative contest. Such a pairing generally requires bets or comparative choices that have roughly even odds or 50-50 chance of likelihood. A positive outcome on an even bet generally yields the same amount of payout as the amount of entry fee or wager (less any applicable commissions for fee payable to the game operator).

### SUMMARY OF THE INVENTION

The present invention is a method to create more comparative choices in sports fantasy or other fantasy games.

### BRIEF DESCRIPTION OF THE DRAWINGS

No drawing is necessary to understand or implement the invention.

### DETAILED DESCRIPTION OF THE INVENTION

A betting or wagering proposition in fantasy sports or other fantasy games generally depends on the comparative performance of two players or characters. Such performance can be measured by a statistic specific to the game and type of position of the player, or by a metric dependent on a number of factors. (A player can refer to either an individual player or to a particular unit, such as the defense and special team units of a football team.) For example, the performance of a running back in fantasy football can be measured by a numerical score based on a number of factors such as rushing yards, touchdowns, and lost fumbles credited to that running back in the relevant period of play (game or quarter of a game). A betting or wagering proposition in fantasy football could be a contest based on a comparative performance between running back X and running back Y in a given game or period of play. A player who picks running back X in such a comparative contest would win if the performance of player X generates a higher numerical score than that of player Y.

A comparative contest could also be based on a group of players rather than just a single player. For example, a fantasy football contest could be based on the comparative performance of two teams, each of which is made up of certain number of players in different positions (such as one quarterback, two running backs, two wide receivers, one tight end, one kicker, one defense and special team unit, etc.) The performance of such a team is the aggregate of the scores of individual players.

All the above variations are based on a simple binary comparison between two choices, that is a comparison between player A and player B, or team A and team B (as assembled by the participants in the fantasy game).

The present invention is a method of extending the range of comparisons that are utilized, thereby providing a game operator a new method and process of creating comparative choices in a contest of fantasy sports or other fantasy games.

Instead of just a comparative choice between player A or player B, or between team A or team B, the new method of this invention would allow the participants in the game to use other comparative choices such as:
Player A versus (the best performance of Player B or Player C);
Player A versus (the worst performance of Player B or Player C);
Player A versus (the average performance of Player B and Player C, i.e., the arithmetic average of the performance scores of B and C);
Player A versus (the combined performance of Player B and Player C);
(The best performance of Player A or Player B) versus (the best performance of Player C or Player D).

The above examples and similar variations provide a new method of creating more comparative choices in sports fantasy or other fantasy games, thereby greatly increasing the ability of a game operator to create fairly even bets or comparative choices without the need for point spreads but are still simple for the users or participants to understand.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A new method of extending the range of comparisons that are utilized in a contest of fantasy sports or other fantasy games, wherein instead of just a comparative choice between player A or player B, or between team A or team B, the participants can use other comparative choices such as:
Player A versus (the best performance of Player B or Player C); or
Player A versus (the worst performance of Player B or Player C); or
Player A versus (the average performance of Player B and Player C, i.e., the arithmetic average of the performance scores of B and C); or
Player A versus (the combined performance of Player B and Player C); or
(The best performance of Player A or Player B) versus (the best performance of Player C or Player D); or
Other similar examples or variations.
